(19) United States
(12) Patent Application Publication
(10) Pub. No.: US 2024/0217409 A1
(43) Pub. Date: Jul. 4, 2024

(54) COVERING ASSEMBLY FOR A VEHICLE SEAT, ASSOCIATED VEHICLE SEAT AND MANUFACTURING METHOD

(71) Applicant: Faurecia Sièges d'Automobile, NANTERRE (FR)

(72) Inventors: Jean-Yves PIEDERRIERE, Angerville (FR); Didier FOUINAT, Saint-Cheron (FR); Fabrice ETIENNE, Bavilliers (FR)

(21) Appl. No.: 18/397,447

(22) Filed: Dec. 27, 2023

(30) Foreign Application Priority Data
Dec. 28, 2022 (FR) FR 22 14594

(51) Int. Cl. B60N 2/58

(52) U.S. Cl. CPC B60N 2/5816; B60N 2/5891

(57) ABSTRACT

A vehicle seat covering assembly having: a first covering element and a second covering element, defining between them a gap, and a zipper that includes a first closure strip, secured to the first covering element, and a second closure strip, secured to the second covering element. The first and second closure strips are secured to each other. The assembly further includes a facing element, disposed between the first closure strip and the first covering element, the facing element extending between the first covering element and the second covering element to conceal the gap.

### TECHNICAL FIELD

The present invention relates to a covering assembly for a vehicle seat. The present invention further relates to a vehicle seat comprising such an assembly and a method for manufacturing such an assembly.

### BACKGROUND

In the field of automotive interior furnishings, it is known to assemble elements, such as covering elements, to one another, for example so that they are easily attached to a support of these elements. To this end, zippers, also called zip fasteners, can be used to secure elements to one another.

A seat covering assembly comprising elements rigidly connected to one another by means of a zipper is thus conceivable. In such a seat covering assembly, a first covering element and a second covering element are for example secured to each other by the zipper and then define between them a gap.

Despite the care taken in arranging the zipper on each of the covering elements of the seat covering assembly, such a covering assembly is not entirely satisfactory.

Indeed, no matter the care taken in design and manufacturing of such covering elements, the zipper is visible through the gap. This then results in a covering assembly having a low perceived quality.

### SUMMARY

One of the aims of the invention is thus to propose a vehicle seat covering assembly whose perceived quality is high.

To this end, the invention relates to a vehicle seat covering assembly comprising:
a first covering element and a second covering element, defining between them a gap, and
a zipper, comprising a first closure strip, secured to the first covering element, and a second closure strip, secured to the second covering element, the first and second closure strips being secured to each other,
the assembly further comprising a facing element, disposed between the first closure strip and the first covering element, the facing element extending between the first covering element and the second covering element to conceal the gap.

The use of a covering assembly comprising such a facing element is particularly advantageous, the facing element concealing the gap thus hiding the zipper and giving the assembly a high perceived quality.

According to other advantageous aspects of the invention, the vehicle seat covering assembly comprises one or more of the following features, taken alone or in any technically feasible combination:
the second covering element is made of a material more rigid than the material of the first covering element;
the second covering element comprises a polyurethane shell;
the assembly is such that:
   the first covering element comprises a first edge and a first covering panel, the first closure strip being secured to the first edge, the first edge being folded on the first covering panel; and
   the second covering element comprises a second edge and a second covering panel, the second closure strip being secured to the second edge, the second edge being folded on the second covering panel;
the facing element is formed by a flexible strip, with longitudinal edges of the flexible strip extending on either side of the gap;
the facing element comprises two portions opposite each other, each of said portions opposite each other extending between the first and the second covering element;
the facing element is formed by a flexible strip folded on itself to define the two portions opposite each other, longitudinal edges of the flexible strip each extending from a single side of the gap;
the facing element is made of the same material as the first covering element.

The invention further relates to a vehicle seat, comprising a seat covering assembly as mentioned above.

The invention further relates to a method for manufacturing a seat covering assembly comprising the following steps:
providing a first covering element and a second covering element separated from each other;
placing a facing element on the first covering element;
securing a first closure strip of a zipper to the first covering element and a second closure strip of the zipper to the second covering member, the first closure strip being attached to the first covering element so that the facing element extends between the first closure strip and the first covering element; and
closing the zipper by securing the first and second closure strips, the facing element concealing a gap extending between the first covering element and the second covering element following the closure of the zipper.

According to other advantageous aspects of the invention, the method for manufacturing a seat covering assembly comprises one or more of the following features, taken alone or in any technically feasible combination:
the facing element put in place is folded on itself;
the first covering element comprises a first edge and a first covering panel, and wherein the second covering element comprises a second edge and a second covering panel,
the first edge being folded over the first covering panel and the second edge being folded over the second covering panel prior to closing the zipper;
the zipper is closed by moving a slider, the method comprising a step of separating the slider from the zipper following the closure of said zipper, in order to obtain the covering assembly.

### BRIEF DESCRIPTION OF THE DRAWINGS

The invention will be better understood on reading the following description, given solely by way of non-limiting example, and referring to the drawings in which:

FIG. 1 is a schematic sectional representation of the components of a seat covering element, during a step of manufacturing the seat covering element;

FIG. 2 is a representation similar to that of FIG. 1, during a step of manufacturing the element being subsequent to that shown in FIG. 1; and

FIG. 3 is a representation similar to that of FIGS. 1 and 2, during a step of manufacturing the element being subsequent to that shown in FIG. 2.

FIG. 4 is a schematic sectional representation of a covering assembly resulting from the manufacturing steps presented in FIGS. 1 to 3.

### DETAILED DESCRIPTION

In the remainder of the description, the terms “front” and “rear” as well as “upper” and “lower” refer to a seat, the front corresponding to the direction in which the legs of a user of the seat extend, opposite to the rear end.

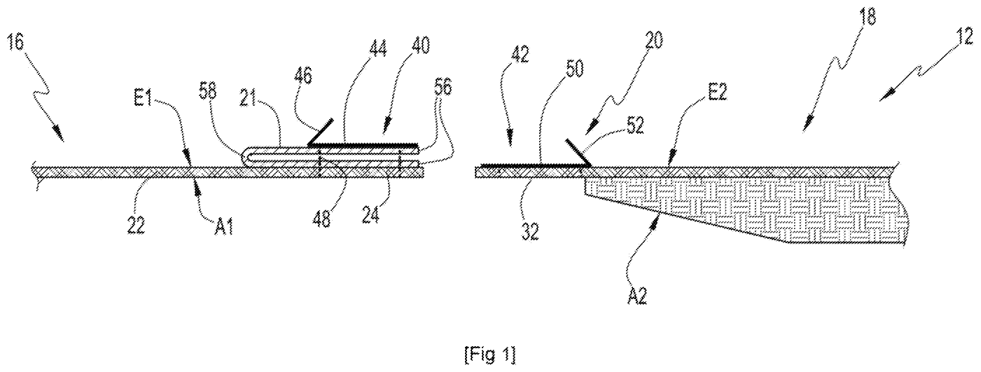

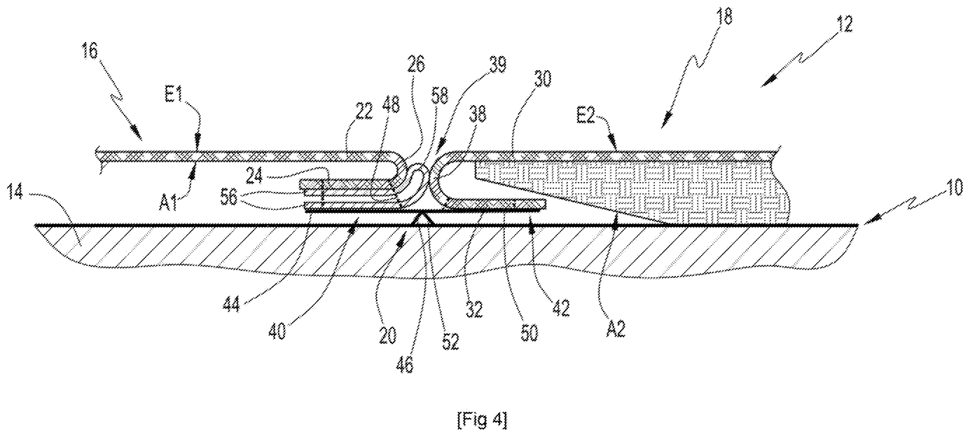

FIG. 4 shows a vehicle seat comprising a covering assembly 12 resulting from the manufacturing steps shown in FIGS. 1 to 3.

The vehicle seat 10 is for example installed in a vehicle passenger compartment (not shown), such as a motor vehicle.

As can be seen in FIG. 4, the support 14 is for example configured to support the seat covering assembly 12.

The support 14 comprises for example a metal structure (not shown) and padding (not shown) carried by the metal structure

As shown in FIG. 4, the seat covering assembly 12, once manufactured, is for example configured to cover the support 14, forming for example a seat cover.

As shown in the Figures, the seat covering assembly 12 comprises a first covering element 16, a second covering element 18, a zipper 20 and a facing element 21.

As in the example of FIG. 4, the first covering element 16 corresponds for example to a front of the vehicle seat 10 and the second covering element 18 for example corresponds to a rear of the vehicle seat 10. The first covering element 16 then extends for example in front of the support 14 and the second covering element 18 extends for example to the rear of the support 14, when the seat 10 is installed in the vehicle. In particular, FIG. 4 shows in detail a sectional view of the side of the seat, the front of the seat corresponding to the left of the figure and the rear of the seat to the right of the figure.

In an alternative embodiment not shown, the first covering element 16 corresponds to a rear of the seat 10 and the second covering element 18 corresponds to a front of the seat.

In other embodiments not shown, at least one of the first 16 and the second 18 covering elements of the seat corresponds to a transverse element of the seat 10, and extends for example on a rim of the seat. Said covering element of the seat 16, 18 then connects, for example, the other covering element of the seat to a complementary covering element (not shown), extending for example to the front or rear of the seat 10

The second covering element 18 is, for example, made of a material more rigid than the material of the first covering element 16. It will be understood, for example, that at least a portion of the second covering element is for example made of a material more rigid than the material of the first covering element 16.

Alternatively, the first covering element 16 and the second covering element 18 are made of the same material

The first covering element 16 is for example made of fabric, for example made of plastic-coated fabric, such as PVC fabrics, or leather, plastic, and/or foam, such as a closed-cell foam. The first covering element 16 is furthermore, for example, made in a superposition of layers made of at least one of the previously cited materials.

As shown in FIG. 4, the first covering element 16 comprises for example a first covering panel 22 and a first edge 24

As shown in FIG. 4, the first covering panel 22 comprises for example an exposed face E1 and a bearing face A1, opposite the exposed face E1. The bearing face A1 is for example mainly configured to bear on the support 14, the exposed face E1 then being for example visible from a passenger compartment of the vehicle (not shown).

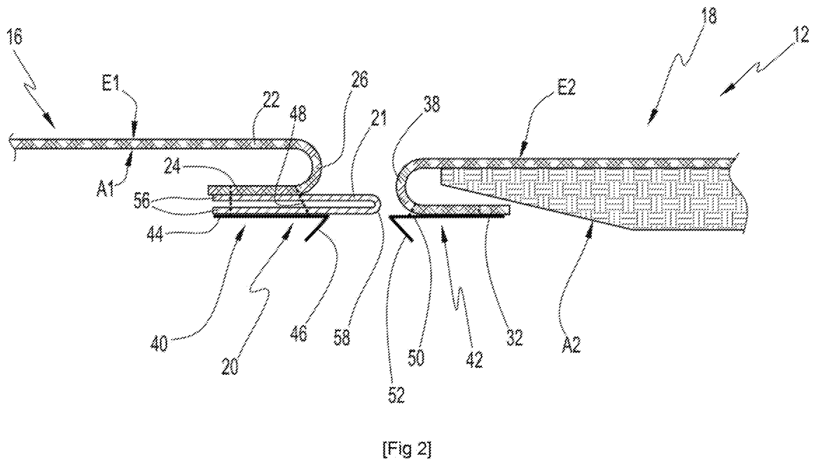

The first edge 24 extends along the first covering panel 22. The first edge 24 extends for example in the continuity of the first panel 22. The first edge 24 for example corresponds to a portion of the first covering element 16 being folded over the first covering panel 22. As can be seen in FIG. 4, the first edge 24 is then for example defined by the first covering panel 22 by a folding line 26 along which the first covering element 16 is folded. Going from FIG. 1 to FIG. 2 particularly illustrates the folding of the first edge 24 on the first covering panel 22 during the manufacture of the first covering element 16.

The second covering element 18 is for example made of fabric, for example made of plastic-coated fabric, such as PVC fabrics, or leather, plastic, and/or foam, such as a closed-cell foam. The first covering element 18 is furthermore, for example, made in a superposition of layers made of at least one of the previously cited materials.

In the example shown in FIGS. 1 to 4, the second covering element comprises two layers superimposed on each other. One of the layers is for example formed by a superposition of sprayed paint and polyurethane forming a skin of the second covering element 18 and the other of the layers is for example formed by a block of polyurethane foam forming a shell of the second covering element 18.

The hardness of the second covering element 18 is for example between 30 and 90 Shore A, the hardness being expressed in Shore A in accordance with the ISO 868 standard

As shown in FIG. 4, the second covering element 18 comprises for example a second covering panel 30 and a second edge 32. In the example shown in FIG. 4 and according to which the second covering element comprises two superimposed layers, the second edge 32 is for example formed by a portion of one of the layers, said portion being for example folded over the other of the layers.

As shown in FIG. 4, the second covering panel 30 comprises for example an exposed face E2 and a bearing face A2, opposite the exposed face E2. The bearing face A2 is for example mainly configured to bear on the support 14, the exposed face E2 then being for example visible from a passenger compartment of the vehicle (not shown).

The second edge 32 extends along the first covering panel 30. The second edge 32 extends for example in the continuity of the second covering panel 30. As will be described in more detail below, the second edge 32 corresponds for example to a portion of the second covering element 18 being folded over the second covering panel 30. As can be seen in FIG. 4, the second edge 32 is then for example defined by the second covering panel 30 by a folding line 38 along which the second covering element 18 is folded. Going from FIG. 1 to FIG. 2 particularly illustrates the folding of the second edge 32 on the first covering panel 30 during the manufacture of the first covering element 16

As shown in FIG. 4, the first covering element 16 and the second covering element 18 define between them a gap 39.

In particular, the gap 39 extends for example between the first 24 and the second edge 32, and for example between the fold lines 26, 38 delimiting said edges 24, 32.

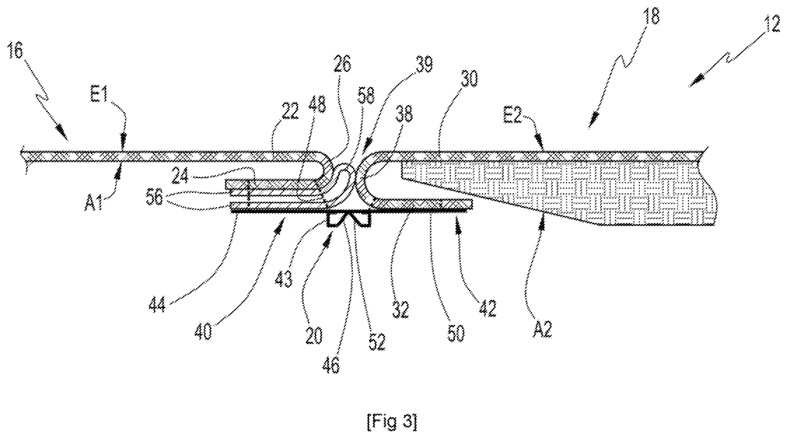

As shown in the figures, the zipper 20 comprises a first closure strip 40 and a second closure strip 42. In a known manner, the zipper comprises for example a slider 43, shown in FIG. 3.

The first closure strip 40 for example comprises a first tape 44 and a set of teeth 46 secured to the first tape 44

As shown in FIGS. 1 to 4, the first closure strip 40 is secured to the first edge 24. The first closure strip 40 is for example sewn to the first edge 24, for example by the first tape 44. As will be described in more detail in the rest of the description, the first closure strip 40 is for example further secured to the facing element 21, the first closure strip 40, the facing element 21 and the first edge 24 being for example secured together by at least one seam 48, and for example by a single seam 48.

As shown in FIG. 4, the first closure strip 40 is secured to the first edge 24 so that the teeth 46 are oriented toward the second covering element 18, in particular to mate with the second covering element 18.

The second closure strip 42 for example comprises a second tape 50 and a set of teeth 52 secured to the second tape 50.

As shown in FIGS. 1 to 4, the first closure strip 42 is secured to the second edge 32. The second closure strip 42 is for example sewn to the second edge 32, for example by the second tape 50.

As shown in FIG. 4, the second closure strip 42 is secured to the second edge 32 so that the teeth 52 are oriented toward the first covering element 16, in particular to mate with the first covering element 16.

As shown in FIG. 4, the teeth 46, 52 are for example engaged with each other and thus secure the first covering element 16 and the second covering element 18. It will then be understood, for example, that the zipper 20 defines an open configuration, shown in FIGS. 1 to 3 and a closed configuration, shown in FIG. 4, enabling the covering element 16 to be manufactured. Thus, the zipper 20 is in its closed configuration in the manufactured covering assembly, as shown in FIG. 4.

As will be understood in the subsequent description of the manufacturing method, the closure strips 40, 42 are away from each other when the zipper is in its open configuration. The teeth 46, 52 of the closure strips 40, 42 are then, for example, not meshed with each other.

In the closed configuration of the zipper 20, the closure strips 40, 42 are secured to each other. The closure strips 40, 42 in particular secure the first 16 and the second 18 covering element. The teeth 46, 52 of the closure strips 40, 42 are then, for example, meshed with each other.

Thus, and as will be described in more detail below, the covering assembly 12 is for example manufactured by meshing the teeth 46, 52 of the closure strips 40, 42 with each other.

As shown in FIG. 3, the slider 43 is for example configured to cooperate with the first 40 and the second 42 closure strips. The slider 43 is in particular movable along the first 40 and second 42 closure strips to reconfigure the zipper 20 between its open and closed positions. In FIG. 3 and to facilitate understanding, the slider 43 is shown in the sectional plane of the figure. However, it will be understood that the slider 43 is for example moved all along the zipper 20 to reconfigure the zipper 20 between its open and closed configurations.

As shown in FIG. 3, illustrating a step of manufacturing the covering assembly 12, the slider 43 is for example configured to fold the first edge 24 onto the first covering panel 22 and to fold the second edge 32 onto the second covering panel 30 during the reconfiguration of the zipper 20 from its open configuration to its closed reconfiguration. In particular, the slider 43 is for example engaged to the first closure strip 40 and to the second closure strip 42 so that said strips 40, 42 are folded by the movement of the slider 43. In particular, the slider 43, by sliding along the strips 40, 42, gradually folds the first edge 24 onto the first covering panel 22 and the second edge 32 onto the second covering panel 30.

As shown in the Figures, the facing element 21 is arranged between the first closure strip 40 and the first covering element 16, for example between the first closure strip 40 and the first edge 24. As shown in the Figures, the facing element 21 is for example sewn between the first closure strip 40 and the first covering element, for example by the seam 48 in order to obtain the assembly shown in FIG. 4

As can be seen in FIG. 4, the facing element 21 is for example secured to the first edge 24 so as to extend towards the second facing element 18.

The facing element 21 extends between the first covering element 16 and the second covering element 18 to conceal the gap 39. Concealing the gap is understood in particular to mean that the facing element 21 prevents the gap from being seen through the gap, or in other words it covers the gap.

As can be seen in FIG. 4, the facing element 21 thus extends opposite the zipper 20.

In a particular embodiment, and as shown in FIG. 4, the facing element at least partially fills the gap 39 by extending at least partially between the first covering element 16 and the second covering element 18 and in the extension of said covering elements 16, 18. For example, as shown in FIG. 4, the facing element 21 is deformed so as to project into the gap 39.

As shown in FIG. 4, the facing element 21 is for example abutted against the second covering element 18. For example, the facing element 21 is deformed between the first covering element 16 and the second covering element 18.

The facing element 21 comprises for example two portions opposite each other. Each of the portions opposite each other extends for example between the first 16 and the second 18 covering elements.

In the example shown in FIG. 4, the facing element 21 is formed by a flexible strip folded back on itself. In particular, the flexible strip folded back on itself is folded back to define the two opposite portions. Longitudinal edges 56 of the flexible strip each extend, for example, from a single side of the gap. The opposite portions of the tape are then secured to the first covering element 16. In particular, as shown in FIG. 4, the opposite portions are for example sewn to the first covering element 16 and to the first closure strip 40. A fold 58 is then for example abutted against the second covering element 18.

In another example, not shown, wherein the facing element 21 comprises two opposite portions, the facing element comprises a tubular element extending between the first 16 and the second 18 covering element. The facing element 21 then comprises, for example, a tongue, said tongue extending for example from one side of the gap 39 so as to hold the tubular element between the first 16 and the second 18 covering element to conceal the gap 39.

In another example not shown, the facing element 21 comprises only a single portion extending between the first 16 and the second 18 covering element. In this other example, the facing element 21 is for example formed by a flexible strip that is not folded back on itself. The longitudinal edges of the flexible strip then extend, for example, on either side of the gap 39.

The facing element 21 is for example made of fabric, for example made of plastic-coated fabric, such as PVC fabrics, or leather, or plastic material such as an elastomer for example.

The facing element 21 is for example made of the same material as the first covering element 16 and/or the second covering element 18.

A method for manufacturing a covering element 12 as described above will now be presented.

During a supply step, a first covering element 16 and a second covering element 18 as presented above are provided, separated from each other.

The supply step is followed by a step of placing a facing element 21 as presented above on the first covering element 16. The facing element 21 is then for example attached to the first covering element 16 and is for example sewn onto the first covering element 16.

During the manufacture of an assembly as shown in FIG. 4, the facing element 21 is folded on itself, as can be seen in FIGS. 1 to 4.

The step of placing a facing element 21 is followed by a securing step. During the securing step, a zipper 20 as previously presented is rigidly connected to the first 16 and the second 18 facing elements 21 provided beforehand. In particular, the first closure strip 40 is secured, for example sewn, to the first covering element 16 and the second closure strip 42 is secured, for example sewn, to the second covering element 18.

In particular, the first closure strip 40 is attached to the first covering element 16 so that the facing element 21 extends between the first closure strip 40 and the first covering element 16. In a particular example, the first closure strip 40 is jointly sewn to the facing element 21 previously placed, so that the first covering element 16, the facing element 21 and the first closure strip 40 are secured to one another.

The assembly resulting from such a securing step is shown in FIG. 1.

Following the securing step, during a folding step, the first edge 24 is for example folded over the first covering panel 22 and the second edge 32 is for example folded onto the second covering panel 30.

The securing step, and for example the folding step, is followed by a step of closing the zipper 20. During this closing step, the first 40 and the second 42 closure strips are secured to each other. Thus, in other words, and as seen above, the zipper 20 is reconfigured from its open configuration to its closed configuration during the securing step.

In a particular example, the zipper 20 is closed by the movement of a slider 43 along the first 40 and second 42 closure strips, the movement of the slider securing said closure strips 40, 42.

In a particular example, the step of closing the zipper 20 and the folding step take place in parallel. For example, in the case where the zipper is closed by the movement of a slider 43, the movement of the slider 43 causes the first edge 24 to be gradually folded back onto the first covering panel 22 and the second edge 32 onto the second covering panel 30.

Following the step of closing the zipper 20, and as shown in FIGS. 3 and 4, the facing element conceals the gap 39 extending between the first covering element 16 and the second covering element 18.

As shown by going from FIGS. 3 to 4, the method further comprises, for example, a step of separating the slider 43, following the step of closing the zipper 20.

During this step, the slider 43 used to secure the first 40 and the second 42 closure strips is separated from the zipper 20 and is in particular moved away from said zipper 20. In such an example, and as shown in FIG. 4, the covering assembly 12 resulting from the manufacturing method is free of a slider 43.

As seen above, and in some variants, the role of the first 16 and the second 18 covering elements can be swapped. For example, according to such variants, the first covering element 16 is made of a material more rigid than the material of the second covering element 18

In a variant not shown, the assembly comprises two facing elements 21, one of the facing elements 21 being arranged between the first covering element 16 and the first closing strip 40, the other of the facing elements 21 being arranged between the second covering element 18 and the second closing strip 42. The facing elements 21 for example each extend opposite the zipper 20, between the first edge 24 and the second edge 32, and are for example abutted against each other. The facing elements 21 then together conceal the gap 39.

In another alternative not shown, the facing element 21 comprises at least one electronic element such as, for example, a light element, the light element being for example configured to illuminate the gap 39 defined between the first 16 and the second 18 covering elements.

1. A vehicle seat covering assembly comprising:
a first covering element and a second covering element, defining between them a gap, and
a zipper, comprising a first closure strip, secured to the first covering element, and a second closure strip, secured to the second covering element, the first and second closure strips being secured to each other,
the assembly further comprising a facing element, disposed between the first closure strip and the first covering element, the facing element extending between the first covering element and the second covering element to conceal the gap.

2. The seat covering assembly according to claim 1, wherein the second covering element is made of a material more rigid than the material of the first covering element.

3. The seat covering assembly according to claim 1, wherein the second covering element comprises a polyurethane shell.

4. The seat covering assembly according to claim 1, wherein:
the first covering element comprises a first edge and a first covering panel, the first closure strip being secured to the first edge, the first edge being folded on the first covering panel; and
the second covering element comprises a second edge and a second covering panel, the second closure strip being secured to the second edge, the second edge being folded on the second covering panel.

5. The seat covering assembly according to claim 1, wherein the facing element is formed by a flexible strip, longitudinal edges of the flexible strip extending on either side of the gap.

6. The seat covering assembly according to claim 1, wherein the facing element comprises two portions opposite each other, each of said portions opposite each other extending between the first and the second covering element.

7. The seat covering assembly according to claim 6, wherein the facing element is formed by a flexible strip folded on itself to define the two portions opposite each other, longitudinal edges of the flexible strip each extending from a single side of the gap.

8. The seat covering assembly according to claim 1, wherein the facing element is made of the same material as the first covering element.

9. A vehicle seat, comprising the seat covering assembly according to claim 1.

10. A manufacturing method for a covering assembly, comprising the following steps:
providing a first covering element and a second covering element separated from each other;
placing a facing element on the first covering element;
securing a first closure strip of a zipper to the first covering element and a second closure strip of the zipper to the second covering member, the first closure strip being attached to the first covering element so that the facing element extends between the first closure strip and the first covering element; and
closing the zipper by securing the first and second closure strips, the facing element concealing a gap extending between the first covering element and the second covering element following the closure of the zipper.

11. The manufacturing method according to claim 10, wherein the facing element placed on the first covering element is folded on itself.

12. The manufacturing method according to claim 10, wherein the first covering element comprises a first edge and a first covering panel, and wherein the second covering element comprises a second edge and a second covering panel,
the first edge being folded over the first covering panel and the second edge being folded over the second covering panel prior to closing the zipper.

13. The manufacturing method according to claim 10, wherein the zipper is closed by moving a slider, the method comprising a step of separating the slider from the zipper following the closure of said zipper, in order to obtain the covering assembly.
